(19) United States
(12) Patent Application Publication
(10) Pub. No.: US 2014/0160761 A1
(43) Pub. Date: Jun. 12, 2014

(54) MODULAR LED LIGHT FIXTURE

(71) Applicant: Hongtao Liu, Dongguan (CN)

(72) Inventor: Hongtao Liu, Dongguan (CN)

(21) Appl. No.: 13/638,374

(22) PCT Filed: Oct. 8, 2011
(86) PCT No.: PCT/CN11/01679

§ 371 Date: Sep. 28, 2012

(30) Foreign Application Priority Data
Aug. 26, 2011 (CN) 201110246977.8

(51) Int. Cl. F21V 29/00

(52) U.S. Cl. CPC F21V 29/004
USPC 362/294; 362/382

(57) ABSTRACT

The invention relates to a modular LED light fixture, which comprises an LED component, an LED drive circuit component, a radiator and a connecting pedestal, wherein the LED component is arranged at the upper end of the inside of the radiator; the LED drive circuit component is arranged at the lower end of the inside of the radiator; the LED component is connected with the LED drive circuit component through leads; the LED drive circuit component is connected with terminals of the connecting pedestal through leads; and the connecting pedestal is fixedly connected with the radiator.

### FIELD OF THE INVENTION

The invention relates to the technical field of LED light fixtures, in particular to a modular LED light fixture.

### BACKGROUND OF THE INVENTION

People had known the fundamentals that semiconductor materials can produce light 50 years ago. The first commercial diode was produced in 1960. LED is short for “light emitting diode”. The basic structure of the LED is as follows: an electroluminescent semiconductor material is placed on a leaded rack and sealed with epoxy resins around to protect internal core threads. LEDs are widely used and have the advantages of long service life, low energy consumption, small size, fast response, shock resistance, low-temperature resistance, less pollution and the like. According to preliminary calculation, the electric power saved by adoption of LED light fixtures in China each year in the future is equivalent to the annual generating capacity of the Three Gorges Power Station, and meanwhile, 80 million tons of CO2, 0.65 million tons of SO2 and 0.32 million tons of NO2 are reduced in emission. Therefore, it is not an exaggeration for calling the LED as “a revolution in the lighting history of human beings”.

Core components of an LED light fixture in the prior art cannot be modular, and an LED chip and a drive circuit are subjected to integral package. Therefore, the LED light fixture has the disadvantages that: firstly, as the LED chip and the drive circuit are subjected to integral package, the LED light fixture is complex in manufacturing technique, cumbersome in assembly and high in production cost; and secondly, as the LED chip and the drive circuit are subjected to integral package, the fault location is difficult to determine in the case of failure, and then the LED light fixture is difficult to maintain no matter whether the LED chip is damaged or the drive circuit fails and the only solution is to abandon the entire package, and thus resulting in huge waste.

### SUMMARY OF THE INVENTION

The technical problem to be solved by the invention is to provide a modular LED light fixture and overcome the defects in the prior art of complex manufacturing technique, cumbersome assembly, high production cost and difficult maintenance of the LED light fixture due to the fact that core components of the LED light fixture cannot be modular.

The technical proposal adopted by the invention to solve the technical problem is as follows:

The invention relates to a modular LED light fixture, which comprises an LED component, an LED drive circuit component, a radiator and a connecting pedestal, wherein the LED component is arranged at the upper end of the inside of the radiator; the LED drive circuit component is arranged at the lower end of the inside of the radiator; the LED component is connected with the LED drive circuit component through leads; the LED drive circuit component is connected with terminals of the connecting pedestal through leads; and the connecting pedestal is fixedly connected with the radiator.

The modular LED light fixture also comprises an optical component which is fixedly connected with the radiator.

The modular LED light fixture also comprises a decorative casing which covers the optical component and is fixedly connected with the radiator.

The modular LED light fixture also comprises an LED component pressing plate which is arranged on the LED component.

As for the modular LED light fixture, the optical component comprises an optical accessory and an optical accessory fixing cover which is threadedly connected with the radiator through an internal connecting screw of the radiator and used for fixing the optical accessory.

As for the modular LED light fixture, the optical accessory is a diffusing disk, a lens or a reflector.

As for the modular LED light fixture, the decorative casing is threadedly connected with the radiator through the external connecting screw of the radiator.

As for the modular LED light fixture, the luminous flux output of the LED component is set to be between 100 lm and 2,500 lm.

As for the modular LED light fixture, the LED drive circuit component realizes high-voltage input dimming constant current output, high-voltage input non-dimming constant current output, low-voltage input dimming constant current output, low-voltage input non-dimming constant current output, constant current input parallel protection dimming rectified current output or constant current input parallel protection non-dimming rectified current output.

As for the modular LED light fixture, the connecting pedestal is adapted to lamp holders in accordance with the standard such as E11, E12, E14, E17, E26, E27, E39, E40, GU6.5, GU10, GU24, GZ10, G9, G12, GX8.5, GX53 and GY6.35.

The modular LED light fixture provided by the invention has the advantages that: as core components of the LED light fixture are modular, namely an LED chip is subjected to single package to form the LED component and an LED drive circuit is subjected to single package to form the LED drive circuit component, the design and the manufacturing technique of the LED light fixture are greatly simplified, and thus the production cost is reduced. Moreover, as the fault location of the product is easy to determine during the use of the LED light fixture, the LED light fixture is convenient in maintenance and the components subjected to integral package do not have to be reluctantly abandoned. Therefore, the technical progress of the LED light fixture can be greatly propelled.

### BRIEF DESCRIPTION OF THE DRAWINGS

FIG. 1 is a schematic diagram of the modular LED light fixture provided by the invention after assembly;

FIG. 2 is a detail drawing of the modular LED light fixture provided by the invention;

FIG. 3 is a schematic diagram of an LED component of the modular LED light fixture provided by the invention;

FIG. 4 is a block diagram of an LED drive circuit for realizing high-voltage input dimming constant current output of the modular LED light fixture provided by the invention;

FIG. 5 is a block diagram of the LED drive circuit for realizing high-voltage input non-dimming constant current output of the modular LED light fixture provided by the invention;

FIG. 6 is a block diagram of the LED drive circuit for realizing low-voltage input dimming constant current output of the modular LED light fixture provided by the invention;

FIG. 7 is a block diagram of the LED drive circuit for realizing low-voltage input non-dimming constant current output of the modular LED light fixture provided by the invention;

FIG. 8 is a block diagram of the LED drive circuit for realizing constant current input parallel protection dimming rectified current output of the modular LED light fixture provided by the invention; and

FIG. 9 is a block diagram of the LED drive circuit for realizing constant current input parallel protection non-dimming rectified current output of the modular LED light fixture provided by the invention.

### DETAILED DESCRIPTION OF THE PREFERRED EMBODIMENTS

Further detailed description is given to the invention with the attached drawings and embodiments.

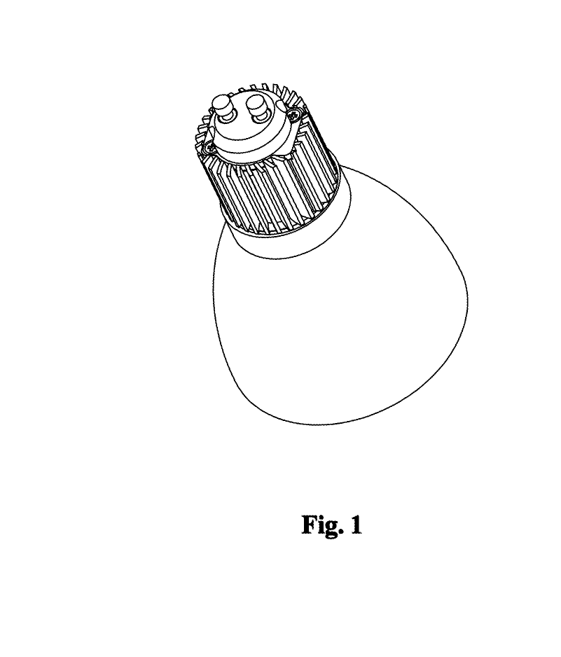

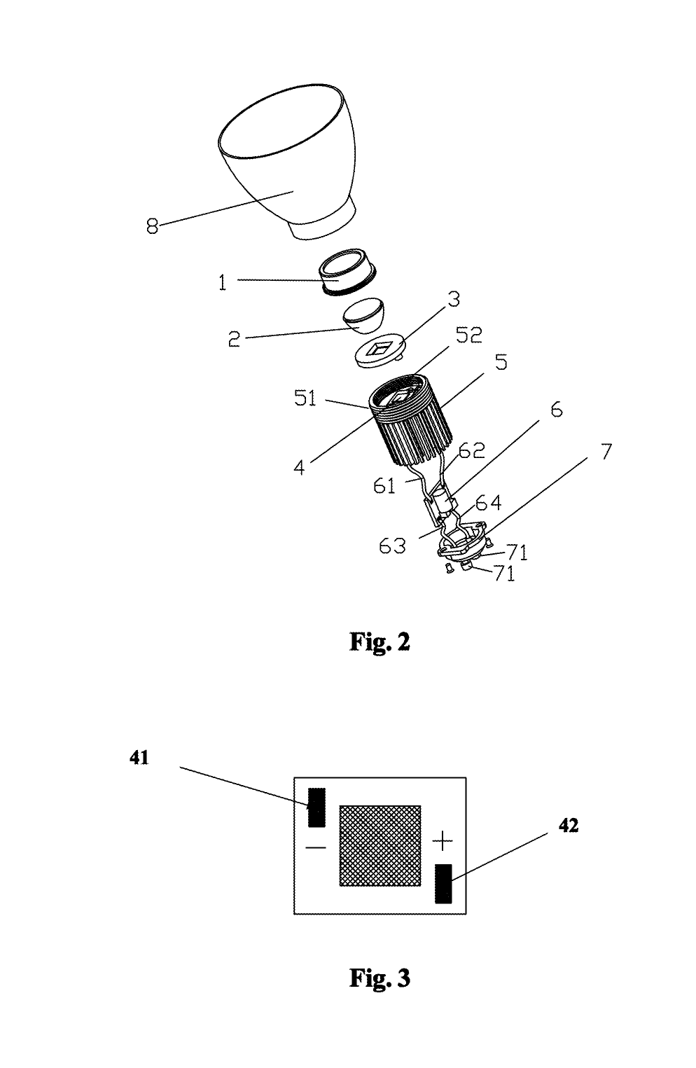

As illustrated in FIGS. 1 and 2, the modular LED light fixture provided by the invention comprises an LED component 4, an LED drive circuit component 6, a radiator 5 and a connecting pedestal 7, wherein the LED component 4 is arranged at the upper end of the inside of the radiator 5; the LED drive circuit component 6 is arranged at the lower end of the inside of the radiator 5; the LED component 4 is connected with the LED drive circuit component 6 through leads 61 and 62; the LED drive circuit component 6 is connected with terminals 71 of the connecting pedestal 7 through leads 63 and 64; the connecting pedestal 7 is fixedly connected with the radiator 5; the luminous flux output of the LED component 4 is set to be between 100 lm and 2,500 lm; and the connecting pedestal 7 is adapted to lamp holders in accordance with the standard such as E11, E12, E14, E17, E26, E27, E39, E40, GU6.5, GU10, GU24, GZ10, G9, G12, GX8.5, GX53 and GY6.35. Moreover, the modular LED light fixture provided by the invention also comprises an optical component which is fixedly connected with the radiator 5 and comprises an optical accessory 2 and an optical accessory fixing cover 1, wherein the optical accessory fixing cover 1 is threadedly connected with the radiator 5 through an internal connecting screw 52 of the radiator 5 and used for fixing the optical accessory 2. Another implementation of the modular LED light fixture provided by the invention is that the optical accessory fixing cover 1 is threadedly connected with the radiator 5 through an external connecting screw 51 of the radiator 5. The optical accessory 2 is a diffusing disk, a lens or a reflector which can be designed to have various different light emitting angles, and then the modular LED light fixture provided by the invention can realize distributed light output from different beam angles. Furthermore, the modular LED light fixture provided by the invention also comprises a decorative casing 8, wherein the decorative casing 8 covers the optical component, is threadedly connected with the radiator 5 through the external connecting screw 51 of the radiator, and can be made of materials such as glass, metals, plastics and ceramics. Still further, the modular LED light fixture provided by the invention also comprises an LED component pressing plate 3 which is arranged on the LED component 4.

As illustrated in FIG. 3, the lead 61 is connected with a cathode welding point 41 of an LED chip and the lead 62 is connected with an anode welding point 42 of the LED chip, so that the electrical connection between the LED drive circuit component 6 and the LED component 4 can be realized.

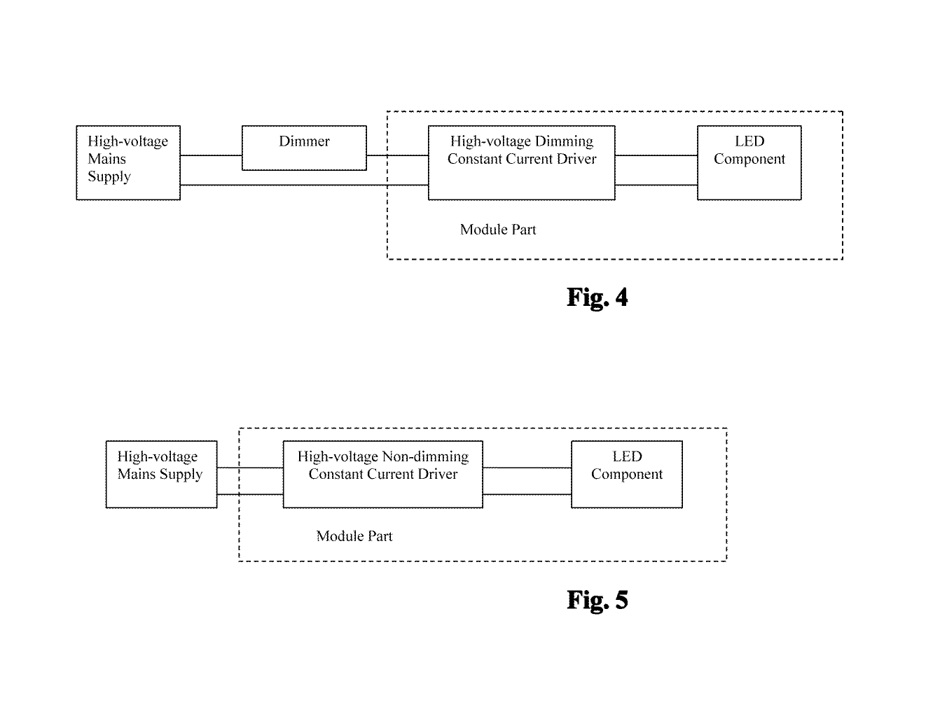

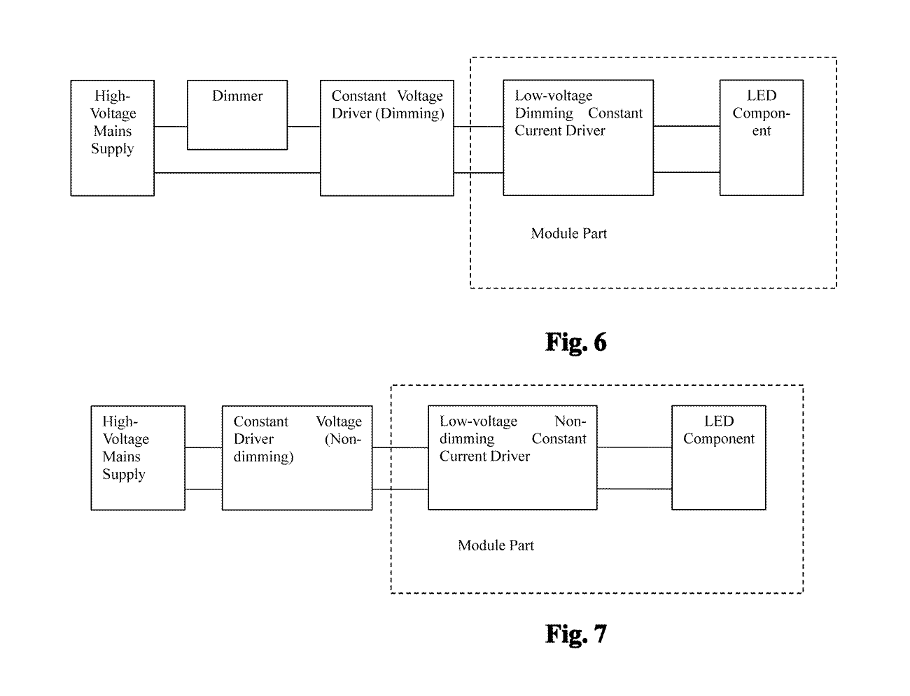

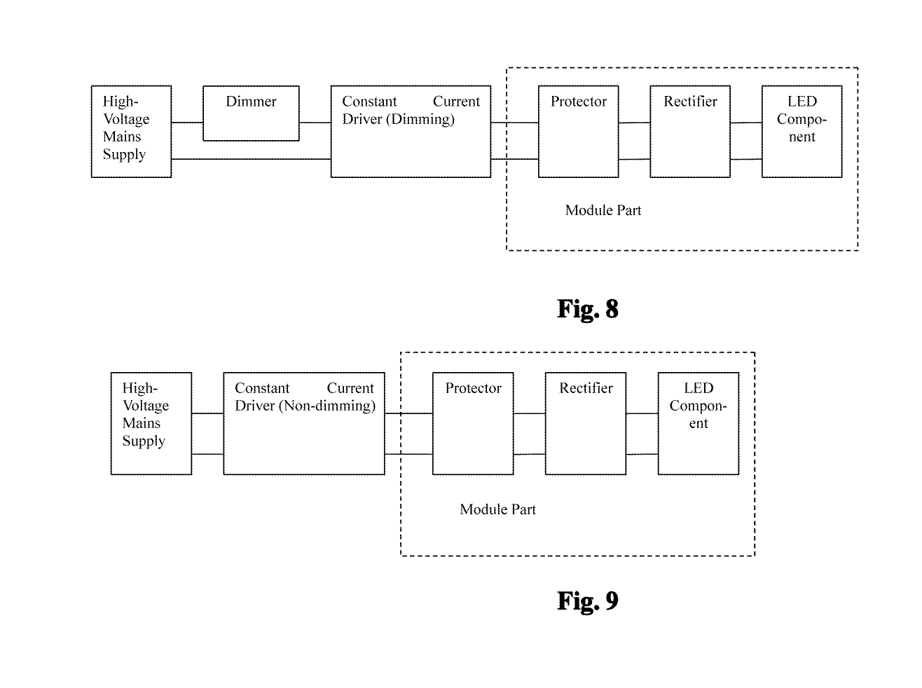

The LED drive circuit of the modular LED light fixture provided by the invention has three modes, which are high-voltage input (dimming or non-dimming) constant current output, low-voltage input (dimming or non-dimming) constant current output and constant current input parallel protection rectified current output respectively. The LED drive circuit is applied to different occasions via the three modes, including dimming application and non-dimming application. For example, FIG. 4 illustrates the LED drive circuit for realizing high-voltage input dimming constant current output; FIG. 5 illustrates the LED drive circuit for realizing high-voltage input non-dimming constant current output; FIG. 6 illustrates the LED drive circuit for realizing low-voltage input dimming constant current output; FIG. 7 illustrates the LED drive circuit for realizing low-voltage input non-dimming constant current output; FIG. 8 illustrates the LED drive circuit for realizing constant current input parallel protection dimming rectified current output; and FIG. 9 illustrates the LED drive circuit for realizing constant current input parallel protection non-dimming rectified current output.

Various deformations of the proposal can be adopted by those skilled in the art to implement the invention without departing from the essence and spirit of the invention. The above only illustrates the preferred embodiments of the invention and is not intended to limit the scope of claims of the invention. Equivalent structure variations made on the basis of the description and the drawings of the invention shall be all within the scope of claims of the invention.

What is claimed is:

1. A modular LED light fixture, comprising an LED component, an LED drive circuit component, a radiator and a connecting pedestal, wherein the LED component arranged at the upper end of the inside of the radiator; the LED drive circuit component arranged at the lower end of the inside of the radiator; the LED component connected with the LED drive circuit component through leads; the LED drive circuit component connected with terminals of the connecting pedestal through leads; and the connecting pedestal fixedly connected with the radiator.

2. The modular LED light fixture according to claim 1, wherein the modular LED light fixture also comprises an optical component which is fixedly connected with the radiator.

3. The modular LED light fixture according to claim 2, wherein the modular LED light fixture also comprises a decorative casing which covers the optical component and is fixedly connected with the radiator.

4. The modular LED light fixture according to claim 3, wherein the modular LED light fixture also comprises an LED component pressing plate which is arranged on the LED component.

5. The modular LED light fixture according to claim 4, wherein the optical component comprises an optical accessory and an optical accessory fixing cover which is threadedly connected with the radiator through an internal connecting screw of the radiator and used for fixing the optical accessory.

6. The modular LED light fixture according to claim 5, wherein the optical accessory is a diffusing disk, a lens or a reflector.

7. The modular LED light fixture according to claim 6, wherein the decorative casing is threadedly connected with the radiator through an external connecting screw of the radiator.

8. The modular LED light fixture according to claim 7, wherein the luminous flux output of the LED component is set to be between 100 lm and 2,500 lm.

9. The modular LED light fixture according to claim 8, wherein the LED drive circuit component realizes high-voltage input dimming constant current output, high-voltage input non-dimming constant current output, low-voltage input dimming constant current output, low-voltage input non-dimming constant current output, constant current input parallel protection dimming rectified current output or constant current input parallel protection non-dimming rectified current output.

10. The modular LED light fixture according to claim 9, wherein the connecting pedestal is adapted to lamp holders in accordance with the standard such as E11, E12, E14, E17, E26, E27, E39, E40, GU6.5, GU10, GU24, GZ10, G9, G12, GX8.5, GX53 and GY6.35.
